(19) United States
(12) Patent Application Publication
(10) Pub. No.: US 2025/0230517 A1
(43) Pub. Date: Jul. 17, 2025

(54) QUENCHING METHOD AND QUENCHING DEVICE

(71) Applicant: NSK Ltd., Shinagawa-ku, Tokyo (JP)

(72) Inventors: Nobuyuki HAGIWARA, Takasaki-shi, Gunma (JP); Naoto KEMMOCHI, Takasaki-shi, Gunma (JP); Kouichi YAMAMOTO, Takasaki-shi, Gunma (JP)

(21) Appl. No.: 18/853,416

(22) PCT Filed: Nov. 30, 2022
(86) PCT No.: PCT/JP2022/044263

§ 371 Date: Oct. 2, 2024

(30) Foreign Application Priority Data
Apr. 5, 2022 (JP) 2022-062808

(51) Int. Cl. C21D 9/40; C21D 1/18; C21D 1/63; C21D 11/00

(52) U.S. Cl. CPC C21D 9/40; C21D 1/18; C21D 1/63; C21D 11/005

(57) ABSTRACT

Disclosed is a quenching method for a quenching object including a race provided with an object through hole. The quenching method includes a step of preparing a quenching tool which is a rod body, a step of suspending a plurality of the quenching objects on the rod body by inserting the quenching tool into the object through hole, and a step of immersing the quenching tool and the quenching objects in a cooling oil. In the step of suspending, each of the quenching objects is disposed on the rod body such that a contact state between the quenching tool and the object through hole is line contact.

### TECHNICAL FIELD

The present disclosure describes a quenching method and a quenching device.

### BACKGROUND ART

Patent Literature 1 discloses a technique related to quenching of metal components. In a quenching method disclosed in Patent Literature 1, quenching objects fed from a feeder are immersed in a quenching agent. The quenching method disclosed in Patent Literature 1 focuses on the postures of the quenching objects when the quenching objects fed from the feeder are immersed in the quenching agent. When the quenching objects fed from the feeder are immersed in the quenching agent, if the quenching objects come into contact with each other and interfere with each other, this will affect the quenching result. In the quenching method disclosed in Patent Literature 1, a plurality of quenching objects are transported in a state in which the quenching objects are not in contact with each other. As a result, the contact between the quenching objects that occurs when the quenching objects are immersed is avoided.

### CITATION LIST

### Patent Literature

[Patent Literature 1] Japanese Unexamined Patent Publication No. 2009-84635

### SUMMARY OF INVENTION

### Technical Problem

When the quenching objects that are heated are immersed in a liquid coolant, a so-called vapor film is generated on the surface of each of the quenching objects. The vapor film present on the surface of the quenching object hinders the transfer of heat from the quenching object to a cooling oil. If there is variation in the state of the vapor film present on the surface of the quenching object, there will also be variation in the degree of cooling of the quenching object. As a result, slight deformation of the quenching object may occur.

The present disclosure describes a quenching tool and a quenching method by which the influence of a vapor film on the result of the quenching can be suppressed.

### Solution to Problem

One aspect of the present disclosure is a quenching method for a quenching object including a disk-shaped portion provided with a through hole. The quenching method includes a step of preparing a rod body, a step of suspending a plurality of the quenching objects on the rod body by inserting the rod body into the through hole, and a step of immersing the rod body and the quenching objects suspended on the rod body in a cooling liquid. In the step of suspending, each of the quenching objects is disposed on the rod body such that a contact state between the rod body and an inner circumferential surface of the through hole is point contact or line contact.

In the quenching method, the quenching object is suspended on the rod body in a state of point contact or line contact. As a result, the quenching object becomes unstable when immersed in the cooling liquid. When the vapor film generated on the surface of the quenching object is separated, the quenching object receives a reaction force F, which allows the quenching object in an unstable state to move slightly. A slight movement of the quenching object promotes the separation of a new vapor film. As a result, the separation of the first vapor film triggers the successive separations of the vapor films to occur, and thus the time from the timing at which the separation of the first vapor film occurs to the timing at which the separation of the vapor film is completed becomes shorter. Therefore, the influence of the difference in the timing at which the vapor film is separated on the result of the quenching can be suppressed.

In the step of preparing of the above-described quenching method, a round rod having a constant outer diameter smaller than an inner diameter of the through hole and a length longer than that of the through hole may be prepared as the rod body. The round rod allows the quenching object to be suspended in an unstable state.

In the step of suspending of the above-described quenching method, the plurality of quenching objects disposed on the rod body may be brought into contact with each other. This process also makes it possible to easily obtain a posture of the quenching object through which the influence of the vapor film on the result of the quenching can be suppressed.

In the step of suspending of the above-described quenching method, the plurality of quenching objects disposed on the rod body may be separated from each other. This process makes it easy to determine whether or not there is a possibility that the vapor film will remain.

In the step of suspending of the above-described quenching method, a part of the quenching object may be overlapped with another quenching object adjacent thereto. Even with such an arrangement, the number of quenching objects that can be disposed on the rod body can be increased.

In the step of preparing of the above-described quenching method, a rod body having an outer diameter smaller than an inner diameter of the through hole and a length longer than that of the through hole may be prepared as the rod body. The rod body may include large diameter portions each having a first outer diameter and small diameter portions each having a second outer diameter smaller than the first outer diameter. The large diameter portions and the small diameter portions may be alternately disposed along an axis of the rod body. This process also makes it easy to determine whether or not there is a possibility that the vapor film will remain.

Another aspect of the present disclosure is a quenching device for a quenching object including a disk-shaped portion provided with a through hole. The quenching device includes a cooling tank filled with a cooling liquid for cooling the quenching object, a detection unit configured to detect that separation of a vapor film from the quenching object has started after the vapor film is generated on a surface of the quenching object by the quenching object being immersed in the cooling liquid, a promotion unit configured to promote the separation of the vapor film from the quenching object, and a controller configured to receive a detection signal from the detection unit indicating that the separation of the vapor film has started and to output a drive signal for causing to the promotion unit to perform an operation for promoting the separation of the vapor film using the detection signal.

The quenching device detects the start of the separation of the vapor film by the detection unit. In the quenching device, when the separation of the vapor film is detected, this detection triggers the separation of the vapor film to be promoted by the promotion unit. According to this configuration, it is possible to reliably promote the separation of the vapor film regardless of whether the quenching object is unstable or not. Therefore, the influence of the difference in the timing at which the vapor film is separated on the result of the quenching can be suppressed.

The detection unit of the above-described quenching device may have a laser generating portion configured to output a laser, a laser receiving portion configured to receive the laser, and a signal output portion configured to output the detection signal when the laser receiving portion does not receive the laser light. According to this configuration, the start of the separation of the vapor film can be detected by a simple mechanism.

The promotion unit of the above-described quenching device may have a rod body which is inserted into the through hole and on which the quenching object is suspended, and a vibration portion configured to vibrate the rod body due to an input of the drive signal. According to this configuration, it is possible to favorably promote the separation of the vapor film.

The promotion unit of the above-described quenching device may have a flow generating portion installed in the cooling tank and configured to generate a flow of the cooling liquid inside the cooling tank due to an input of the drive signal. According to this configuration, it is also possible to favorably promote the separation of the vapor film.

The promotion unit of the above-described quenching device may have a housing configured to accommodate the cooling tank, and a pressure reduction portion configured to reduce a pressure inside the housing below atmospheric pressure due to an input of the drive signal. According to this configuration, it is also possible to favorably promote the separation of the vapor film.

### Advantageous Effects of Invention

According to the quenching method and the quenching device of the present disclosure, the influence of a vapor film on the result of the quenching can be suppressed.

### BRIEF DESCRIPTION OF DRAWINGS

FIG. 1 is a schematic diagram showing quenching equipment to which a quenching method of a first disclosure is applied.

FIG. 2 is a cross-sectional view of a quenching object suspended on a quenching tool.

FIG. 3 is a front view of the quenching object suspended on the quenching tool.

FIG. 4(a) is a diagram showing how the quenching object moves due to a reaction force. FIG. 4(b) is a diagram showing how the quenching object moves in another direction due to a reaction force.

FIG. 5(a) is a graph showing a temperature change of the quenching object. FIG. 5(b) is a diagram showing a state of the quenching object immediately after the quenching object has been immersed in a cooling oil. FIGS. 5(c), 5(d), and 5(e) are schematic diagrams showing how a vapor film separates from the quenching object.

FIG. 6(a) is a graph showing a temperature change in a case in which the quenching object is unstably suspended. FIG. 6(b) is a schematic diagram showing a state immediately after the vapor film has been generated. FIG. 6(c) is a schematic diagram showing how the separation of the vapor film first occurs. FIG. 6(d) is a schematic diagram showing how the separation of the vapor film successively occurs.

FIG. 7 is a flowchart showing a quenching method.

FIG. 8(a) is a diagram showing a first condition of Experimental Example 1. FIG. 8(b) is a diagram showing a second condition of Experimental Example 1.

FIG. 9(a) is a graph showing the result of measurement of the warpage of a race in Experimental Example 1. FIG. 9(b) is a graph showing the result of measurement of the roundness of a lip in Experimental Example 1.

FIG. 10(a) is a diagram showing a third condition of Experimental Example 2. FIG. 8(b) is a diagram showing a fourth condition of Experimental Example 2.

FIG. 11(a) is a graph showing the result of measurement of the warpage of a race in Experimental Example 2. FIG. 11(b) is a graph showing the result of measurement of the roundness of a lip in Experimental Example 2.

FIGS. 12(a) and 12(b) are diagrams showing a quenching device according to a second disclosure.

FIGS. 13(a) and 13(b) are diagrams showing a quenching device according to a third disclosure.

FIGS. 14(a) and 14(b) are diagrams showing a quenching device according to a fourth disclosure.

FIG. 15(a) is a diagram showing a first modification example in which a quenching object is suspended on a quenching tool. FIG. 15(b) is a diagram showing a second modification example in which a quenching object is suspended on a quenching tool.

FIG. 16 is a diagram showing a third modification example in which a quenching object is suspended on a quenching tool.

FIG. 17(a) is a diagram showing a fourth modification example in which a quenching object is suspended on a quenching tool. FIG. 17(b) is a diagram showing a fourth modification example in which a quenching object is suspended on a quenching tool.

FIGS. 18(a), 18(b), and 18(c) are examples of the quenching object that can be quenched by the quenching method and the quenching device.

### DESCRIPTION OF EMBODIMENTS

Hereinafter, a quenching method and a quenching device according to a first disclosure will be described in detail with reference to the accompanying drawings. In the description of the drawings, the same elements are denoted by the same reference signs and overlapping descriptions are omitted.

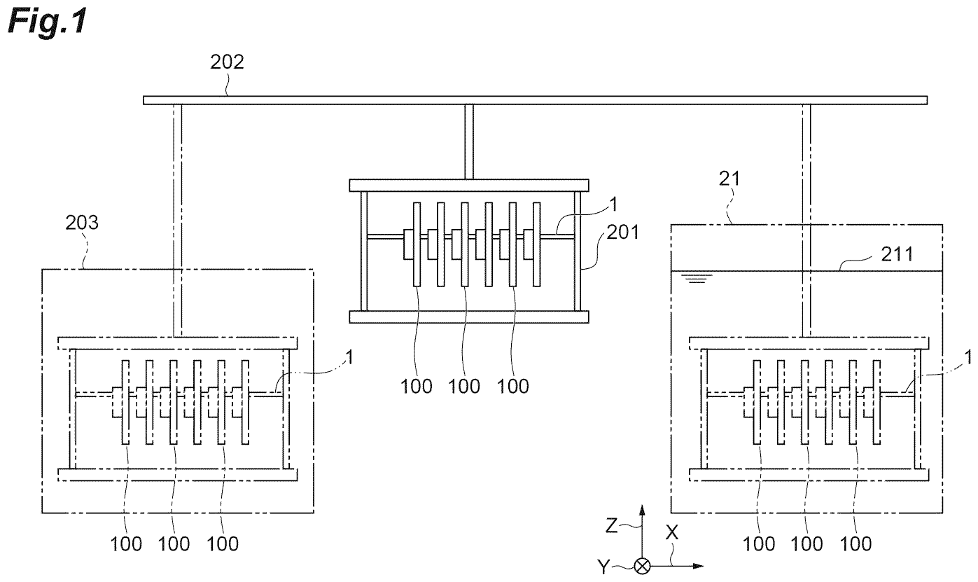

FIG. 1 is a schematic diagram showing quenching equipment to which a quenching tool 1 is applied. A quenching object 100 is a component of a bearing. For example, the quenching object 100 is used for a needle thrust bearing, a needle shell bearing, a thin-walled bearing, a large diameter bearing, and the like.

As shown in FIG. 1, the quenching tool 1 is suspended by a suspension cage 201 or the like. The suspension cage 201 is connected to a moving mechanism 202. The moving mechanism 202 moves the quenching tool 1 from a heating furnace 203 to a cooling tank 21. The quenching equipment processes a large number of quenching objects 100 in batches.

The quenching tool 1 holds a plurality of quenching objects 100. The quenching tool 1 holds the quenching objects 100 in an unstable state when the quenching objects 100 are immersed in a cooling oil 211 (a cooling liquid).

### Quenching Object

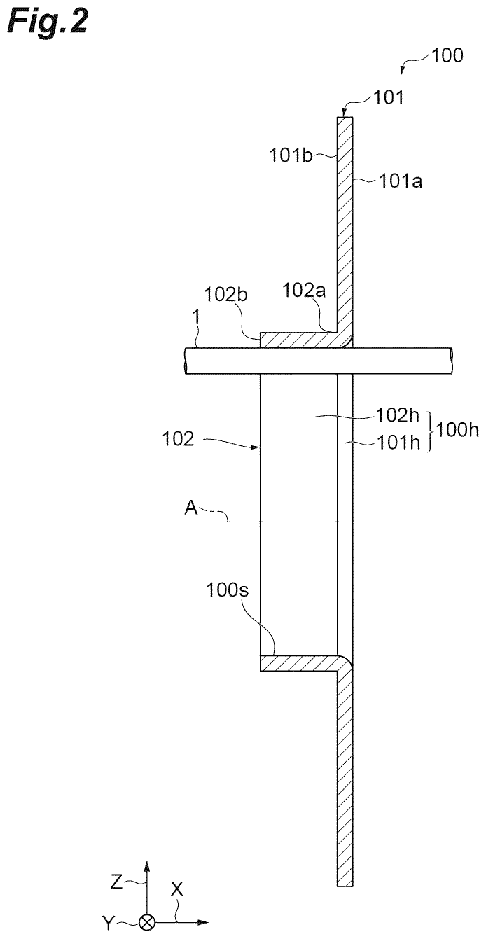

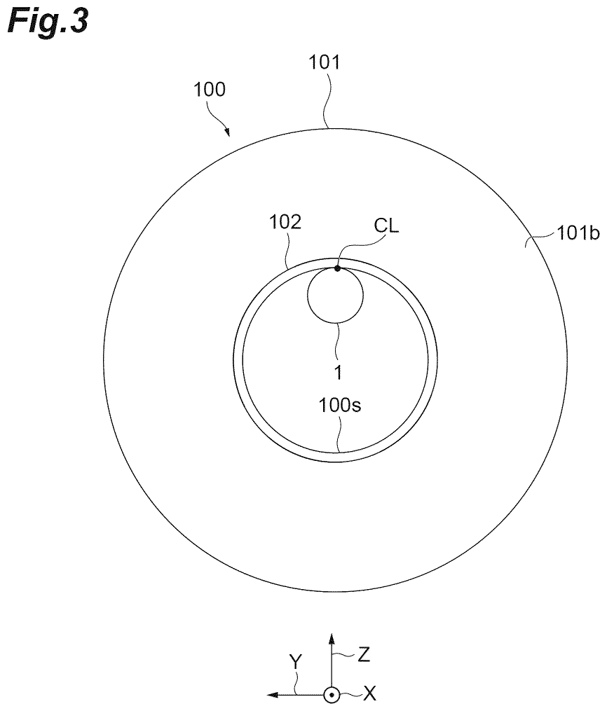

As shown in FIGS. 2 and 3, the quenching object 100 has a disk-shaped race 101 (a disk-shaped portion) and a cylindrical lip 102. The shape of the quenching object 100 is not limited to that shown in FIG. 1. Some other examples of the shape of the quenching object 100 will be given in a section of modification examples, which will be described below.

The race 101 is a thin plate having a thickness smaller than its outer diameter. When the quenching object 100 is immersed in the cooling oil 211, the surface of the quenching object 100 that comes into contact with the cooling oil 211 is rapidly cooled. The heat inside the quenching object 100 is sequentially transferred to the surface of the quenching object 100. Strictly speaking, there is a difference in the cooling manner between the surface side and the interior side of the quenching object 100. However, the thickness of the quenching object 100 exemplified in the first disclosure is thin. Therefore, it can be considered that there is substantially no difference in the cooling manner between the surface and the inside of the quenching object 100. The term “thin plate” in the first disclosure means a plate that can be considered to have substantially no difference in the cooling manner between the surface and the inside during cooling.

The race 101 has a race main surface 101a, a race back surface 101b, and a race through hole 101h. The race main surface 101a is a flat surface having substantially no unevenness. The lip 102 is provided on the race back surface 101b. The lip 102 extends from the race back surface 101b in a normal direction of the race back surface 101b. The race 101 and the lip 102 are press-formed from a single plate material. Therefore, there is no physical boundary that separates the race 101 and the lip 102 from each other.

The central axis of the lip 102 coincides with the central axis of the race 101. The lip 102 is coaxial with the race 101. The lip 102 has a lip base end 102a, a lip tip end 102b, and a lip through hole 102h. The lip base end 102a is connected to the race back surface 101b. The lip tip end 102b is a free end. The height of the lip 102 may be less than the outer diameter of the lip 102. The lip through hole 102h forms an object through hole 100h together with the race through hole 101h. The inner diameter of the lip through hole 102h is the same as the inner diameter of the race through hole 101h.

The result of the quenching can be evaluated, for example, using the warpage of the race 101 and the roundness of the lip 102. If the state of the quenching is not uniform, the warpage of the race 101 may occur. If the state of the quenching is not uniform, the roundness of the lip 102 may be reduced.

### Quenching Tool

The quenching object 100 is suspended on the quenching tool 1. FIGS. 2 and 3 show a state in which one quenching object 100 is suspended on the quenching tool 1. A plurality of quenching objects 100 may be suspended on the quenching tool 1. The quenching tool 1 is a single rod body. The rod body may be a round rod. The rod body may be a square rod. The quenching tool 1 is inserted into the object through hole 100h of the quenching object 100. The length of the quenching tool 1 is at least greater than the length of the lip 102. A first end portion of the quenching tool 1 protrudes from the race main surface 101a. A second end portion of the quenching tool 1 protrudes from the lip tip end 102b.

The outer diameter of the quenching tool 1 is smaller than the inner diameter of the object through hole 100h. The quenching tool 1 is in contact with a through hole inner circumferential surface 100s surrounding the object through hole 100h. The upper side of the outer circumferential surface of the quenching tool 1 in a vertical direction is in contact with the through hole inner circumferential surface 100s. Since the quenching tool 1 is a round rod and the through hole inner circumferential surface 100s is also cylindrical, the quenching tool 1 and the through hole inner circumferential surface 100s are ideally in line contact with each other. From the viewpoint of suppressing the influence of a vapor film on the result of the quenching, the smaller the contact area between the quenching tool 1 and the through hole inner circumferential surface 100s, the better. As shown in FIG. 3, the smaller the outer diameter of the quenching tool 1 with respect to the inner diameter of the through hole inner circumferential surface 100s, the better. As the outer diameter of the quenching tool 1 with respect to the inner diameter of the through hole inner circumferential surface 100s becomes smaller, the contact area between the quenching tool 1 and the through hole inner circumferential surface 100s becomes smaller, thereby approaching the state of an ideal line contact.

In a case in which a square rod is used as the quenching tool 1, the corners of the square rod only have to be in contact with the through hole inner circumferential surface 100s of the object through hole 100h.

The outer circumferential surface of the quenching tool 1 shown in FIG. 3 is not provided with any uneven structure that would hinder the movement of the quenching object 100. For example, it is assumed that a groove corresponding to the thickness of the quenching object 100 along an object axis A is present on the outer circumferential surface of the quenching tool 1. In this case, when the quenching object 100 is fit into the groove, the movement of the quenching object 100 in a direction of the object axis A is restricted. The quenching tool 1 of the first disclosure is not provided with such a groove.

The quenching tool 1 is not limited to the round rod without unevenness as shown in FIGS. 2 and 3. Modified examples of a quenching tool 1A having unevenness are illustrated in Modification Examples 4 and 5.

The lower side of the outer circumferential surface of the quenching tool 1 in a vertical direction is not in contact with the through hole inner circumferential surface 100s. There is a large gap between the lower side of the outer circumferential surface of the quenching tool 1 in the vertical direction and the through hole inner circumferential surface 100s.

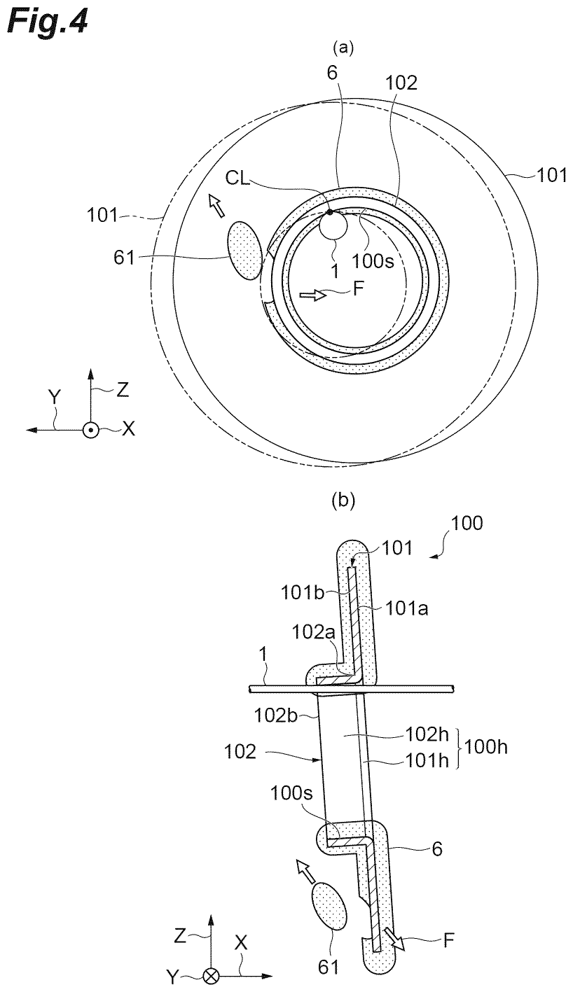

In a case in which the quenching object 100 is suspended on the quenching tool 1, the quenching object 100 will not fall because it is supported by the quenching tool 1. The quenching object 100 is permitted to undergo three movements. First, the quenching object 100 can swing about a contact portion CL with the quenching tool 1 as a fulcrum (see FIG. 4(a)). Second, the quenching object 100 can be moved back and forth (in an X direction) along the object axis A (see FIG. 4(b)). Third, the quenching object 100 can also be moved in a direction orthogonal to the object axis A (in a Z direction).

The quenching object 100 can move easily by a slight force. The quenching object 100 is a small and lightweight metal component. The outer diameter of the race 101 of the quenching object 100 is, for example, about 10 mm to 400 mm. The height of the lip 102 is, for example, about 1 mm to 10 mm. The mass of the quenching object 100 is, for example, about 1 gram to 20 grams.

### Principle That Can Be Considered

The inventors have studied the phenomenon that occurs when the quenching object 100 suspended on the quenching tool 1 is immersed in the cooling oil 211. As a result, the inventors have come up with the following two hypotheses.

### First Hypothesis

The quenching object 100, which has been heated to a predetermined temperature, is immersed in the cooling oil 211. As a result, a vapor film 6 is generated on the surface of the quenching object 100 due to the heat of the quenching object 100. A comparison will be made between a case in which the quenching object 100 is in direct contact with the cooling oil 211 and a case in which the quenching object 100 is in contact with the vapor film 6. The vapor film 6 is a gas. Therefore, in the latter case, heat is apparently less likely to transfer from the quenching object 100 to the cooling oil 211 than in the former case. In the quenching, it is desirable that the quenching object 100 be cooled at a predetermined cooling rate. In the quenching, the presence of the vapor film 6 can be an obstacle to achieving the desired quenching.

The cooling of the quenching object 100 will be described in more detail. It has been stated above that the cooling rate is important in order to produce a desired structure such as martensite in the quenching object 100. In a case in which the cooling rate that occurs when the quenching object 100 is immersed in the cooling oil 211 is slower than a reference cooling rate determined on the basis of the experimental result or the like, another structure such as pearlite will also be produced in addition to the martensite. Therefore, the cooling rate of the quenching object 100 has not to be slower than the reference cooling rate.

The inventors have come to the conclusion that in order to obtain a good result of the quenching, it is important not only to focus on the cooling rate, but also on the timing at which the cooling starts.

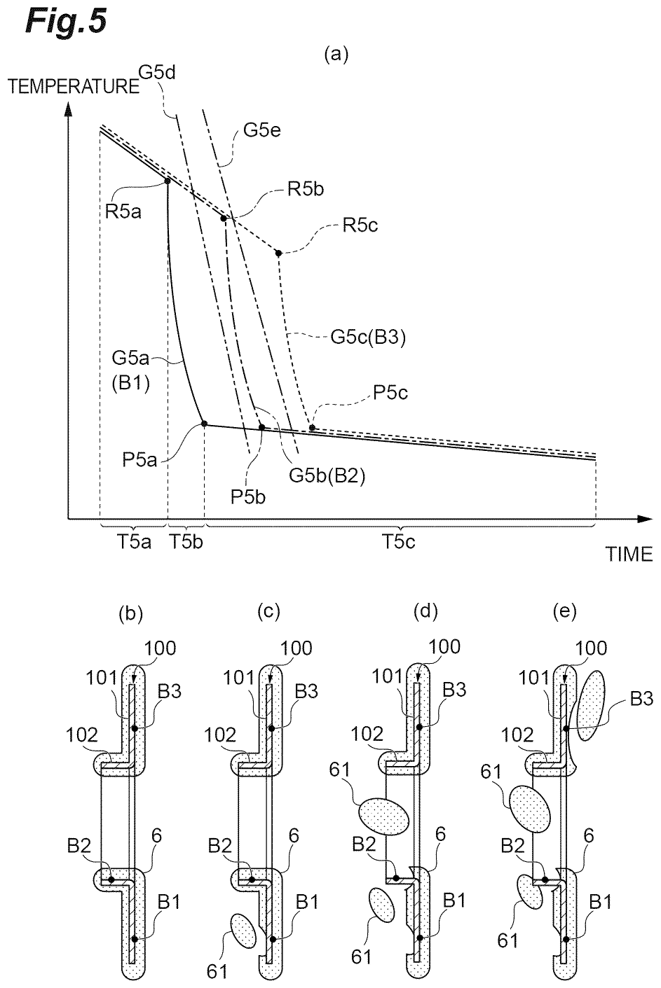

FIG. 5(a) is a graph showing the temperature change of the quenching object 100 that occurs when the quenching object 100 is immersed in the cooling oil 211. A graph G5a shows the temperature change at a lower portion (a position B1) of the race 101 in the quenching object 100 shown in FIG. 5(b). A graph G5b shows the temperature change at a lower portion (a position B2) of the lip 102. A graph G5c shows the temperature change at an upper portion (a position B3) of the race 101.

A graph G5d is a first cooling reference line. A graph G5e is a second cooling reference line. In a case in which the temperature history that occurs when the quenching object 100 is cooled is present in the range to the left of the graph G5d, a first structure (for example, martensite) is formed. In a case in which the temperature history that occurs when the quenching object 100 is cooled is present between the graph G5d and the graph G5e, the first structure (for example, martensite) and a second structure (for example, pearlite) are mixed with each other. In a case in which the temperature history that occurs when the quenching object 100 is cooled is in the range to the right of the graph G5e, the second structure (for example, pearlite) is formed.

Attention is given to the graph G5a. Immediately after the quenching object 100 is immersed in the cooling oil 211, the vapor film 6 is generated on the surface of the quenching object 100 (see FIG. 5(b)). The vapor film 6 hinders the transfer of heat from the quenching object 100 to the cooling oil 211. Therefore, the temperature of the quenching object 100 is gradually decreased (a period T5a: a period during which the vapor film is present). Thereafter, some events trigger the vapor film 6 to be separated from the surface of the quenching object 100 (see FIGS. 5(c), 5(d), and 5(e)). The surface of the quenching object 100 comes into direct contact with the cooling oil 211 at the moment that the vapor film 6 is separated therefrom. The phenomenon in which the vapor film 6 is separated from the surface of the quenching object 100 may be referred to as boiling. The vapor film 6 separated from the quenching object 100 may be referred to as a bubble 61. When the quenching object 100 comes into direct contact with the cooling oil 211, this direct contact triggers the temperature of the quenching object 100 to be rapidly decreased (a period T5b: a rapid cooling period). The period during which the temperature of the quenching object 100 is rapidly decreased may be referred to as a boiling period. After the temperature of the quenching object 100 has been decreased to a predetermined value, the temperature of the quenching object 100 is slowly decreased (a period T5c: a slow cooling period).

An important point is that a boundary point P5a between the period T5b during which the temperature of the quenching object 100 is rapidly decreased and the sequent period T5c during which the temperature of the quenching object 100 is slowly decreased is present on the left side of the graph G5d. The boundary point P5a of the graph G5a is present at the left side of the graph G5d, which indicates that the desired structure (martensite) could be generated.

Attention is given to the graph G5b. Like the graph G5a, the graph G5b also includes a period during which the vapor film 6 is present, a rapid cooling period, and a slow cooling period. On the other hand, the timing (a point R5b) at which the rapid cooling period starts in the graph G5b is later than the timing (a point R5a) at which the rapid cooling period (a period T5b) starts in the graph G5a. Even in the period T5a during which the vapor film 6 is present, the temperature continues to decrease, and thus the temperature decreases as time passes. The temperature at which the rapid cooling period starts in the graph G5b is lower than the temperature at which the rapid cooling period (the period T5b) starts in the graph G5a. As a result, even if the cooling rate in the rapid cooling period of the graph G5b is the same as the cooling rate of the graph G5a, a boundary point P5b of the graph G5b is present between the graph G5d and the graph G5e. In this case, in addition to the desired structure such as martensite, another structure such as pearlite is also generated.

Attention is given to the graph G5c. Like the graph G5a, the graph G5c also includes a period during which the vapor film is present, a rapid cooling period, and a slow cooling period. The timing (a point R5c) at which the rapid cooling period starts in the graph G5c is later than the timing (a point R5a) at which the rapid cooling period (T5b) starts in the graph G5a. As a result, the boundary point P5c of the graph G5c is present on the right side of the graph G5e. In this case, instead of the desired structure such as martensite, another structure such as pearlite is generated.

The inventors have come to the conclusion that even if the cooling rate is the same, depending on the timing (the point R5a, the point R5b, or the point R5c) at which the rapid cooling period starts, the desired structure cannot be generated. The timing at which the rapid cooling period of the quenching object 100 starts can be regarded as the timing at which the quenching object 100 comes into contact with the cooling oil 211. The timing at which the quenching object 100 comes into contact with the cooling oil 211 is the timing at which the vapor film 6 is separated from the quenching object 100.

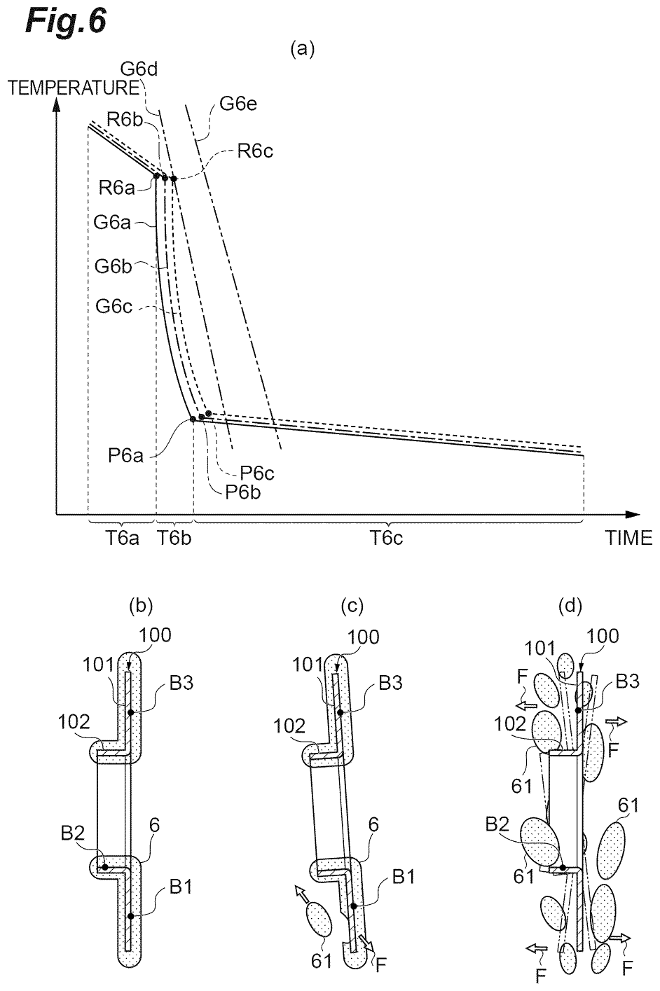

Therefore, as shown in FIG. 6, if a gap from the timing (a point R6a) at which the separation of the vapor film 6 first occurs to the timing (a point R6c) at which the separation of the vapor film 6 is completed is reduced, it is possible to generate the desired structure in all portions of the quenching object 100.

The graph in FIG. 6(a) shows the temperature change of the quenching object 100 in a case in which the quenching method of the first disclosure is applied. The graph in FIG. 6(a) shows the temperature change of the quenching object 100. The temperature change of the quenching object 100 shown in the graph of FIG. 6(a) occurs when the quenching object 100 that is unstably supported is immersed in the cooling oil 211. A graph G6a shows the temperature change at a lower portion (a position B1) of the race 101 in the quenching object 100 shown in FIG. 6(b). A graph G6b shows the temperature change at a lower portion (a position B2) of the lip 102. A graph G6c shows the temperature change at an upper portion (a position B3) of the race 101. A graph G6d has the same meaning as the graph G5d. A graph G6e also has the same meaning as the graph G5e.

### Second Hypothesis

In short, the inventors considered that, as the first hypothesis, the gap in timing at which the separation of the vapor film 6 occurs may cause a variation in the structure of the quenching object 100, and that this variation in the structure affects the shape accuracy of the quenching object 100. By reducing the gap in timing at which the separation of the vapor film 6 occurs, uniformity of the structure is achieved. As a result, the inventors considered that when the influence of the vapor film 6 is suppressed, the desired shape accuracy can be achieved.

Through further investigation, the inventors found a second hypothesis that it may be possible to further suppress the influence of the vapor film 6.

In the example shown in FIG. 6, the gap in timing at which the separation of the vapor film 6 occurs is suppressed more than in the example shown in FIG. 5. However, the gap in timing at which the separation of the vapor film 6 occurs (for example, the gap between the point R6a and the point R6c) is not zero, but is present although it is slight. Even a gap of this degree may have small but significant influence on the shape accuracy of the quenching object 100.

The degree of expansion of martensite is greater than the degree of expansion of another structure. For example, martensite is produced by the occurrence of the separation of the vapor film 6 at the position B1 on the race surface. As a result, the position B1 expands. Thereafter, martensite is produced by the occurrence of the separation of the vapor film 6 at another position B3 in the race 101. As a result, the position B3 also expands. When expansion occurs at the position B3, the expansion at the position B3 interferes with the previously occurring expansion at the position B1. This may result in warpage.

In a case in which even greater accuracy of a shape is required than can be achieved by homogenizing the structure, it is desirable to further reduce the gap in timing at which the separation of the vapor film 6 occurs (the timing at which the cooling starts).

The inventors imagined that when the vapor film 6 is separated, a reaction force F acts on the quenching object 100 in a direction opposite to the direction in which the vapor film 6 is separated. As described above, as shown in FIG. 4(a), when a part of the vapor film 6 is separated from the lip 102, it could also be expected that the quenching object 100 swings around the contact portion CL between the quenching tool 1 and the quenching object 100 as a fulcrum due to the reaction force F. For example, as shown in FIG. 4(b), when a part of the vapor film 6 is separated from the race 101, it could also be expected that the quenching object 100 moves in a tilting manner due to the reaction force F.

Since the vapor film 6 is unstable, the separation of the vapor film 6 occurs due to an external factor such as the application of an external force. Therefore, the reaction force F acting on the quenching object 100 due to the separation of the vapor film 6 is utilized. When the quenching object 100 moves even slightly due to the reaction force F, this movement triggers the separation of the vapor film 6 in another portion of the quenching object 100 to occur. The separation of the vapor film 6, the movement of the quenching object 100 due to the reaction force F, and the separation of a new vapor film 6 due to the movement of the quenching object 100 are repeated, thereby promoting the separation of the vapor film 6.

The promoting effect of the separation of the vapor film 6 is premised on the fact that the quenching object 100 is capable of moving. The quenching tool 1 employs line contact in order to unstably support the quenching object 100.

As shown in FIG. 6, for example, in a case in which the quenching tool 1 is used, the separation of the first vapor film 6 (see FIG. 6(c)) triggers the successive separations of the vapor films 6 to occur (see FIG. 6(d)). As a result, as shown in FIG. 6(a), it is possible to shorten the period from the timing (the point R6a) at which the separation of the first vapor film 6 occurs to the timing (the point R6c) at which the separation of the last vapor film 6 occurs. If the separation of the vapor film 6 is referred to as the boiling, the above period shortening can also be said to be shortening the period from the timing at which the first boiling occurs (the point R6a) to the timing at which the last boiling occurs (the point R6c). As a result, it is possible to generate the boundary points P6a, P6b, and P6c at all portions on the left side of the graph G6d. As a result of the suppression of the influence of the vapor film 6 on the result of the quenching, a desired result of the quenching can be obtained.

In contrast, in a case in which the quenching object 100 is fixed, the separation of the first vapor film 6 does not trigger the separation of the vapor film 6 at another position. The separation of the vapor film 6 occurs separately for a reason separate from the movement of the quenching object 100. As a result, the period from the timing (the point R5a) at which the separation of the first vapor film 6 occurs to the timing (point R5c) at which the separation of the last vapor film 6 occurs is longer than that in the case in which the quenching tool 1 is used as shown in FIG. 5(a). Therefore, there may be a case in which the boundary points P5b and P5c are not present on the left side of the graph G5d. Since the vapor film 6 affects the quenching, the desired quenching result cannot be obtained.

### Quenching Method

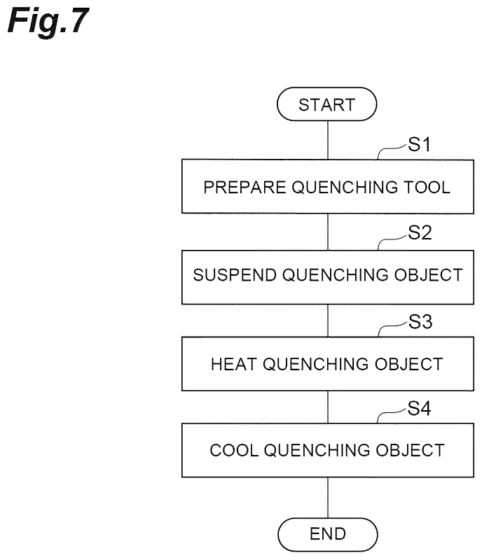

Next, a quenching method using the quenching tool 1 will be described with reference to FIG. 7.

A rod body serving as the quenching tool 1 is prepared (step S1). The details of the quenching tool 1 have already been described.

A plurality of quenching objects 100 are suspended on the quenching tool 1 by inserting the rod body into the object through hole 100h (step S2). In the step S2, each of the quenching objects 100 is disposed on the quenching tool 1 such that a contact state between the quenching tool 1 and the through hole inner circumferential surface 100s of the object through hole 100h is line contact. The quenching tool 1 is a round rod. The through hole inner circumferential surface 100s is a curved surface. Therefore, the contact state between the quenching tool 1 and the through hole inner circumferential surface 100s is line contact.

The quenching tool 1 and the plurality of quenching objects 100 suspended on the quenching tool 1 are disposed in the heating furnace 203 (step S3). In the heating furnace 203, the quenching object 100 is heated to a predetermined temperature.

The quenching tool 1 and the plurality of quenching objects 100 suspended on the quenching tool 1 are immersed in the cooling oil 211 (step S4). When the heated quenching object 100 is immersed in the cooling oil 211, the vapor film 6 is generated. When the first vapor film 6 is separated from the quenching object 100, this separation triggers the successive separations of the vapor films 6 to occur. As a result, it is possible to reduce the variation in the period during which the entire quenching object 100 is cooled to a predetermined temperature.

### Action and Effect

In short, the quenching method of the first disclosure is a quenching method for the quenching object 100 including the race 101 provided with the object through hole 100h. The quenching method includes a step S1 of preparing a quenching tool 1 which is a rod body, a step D2 of suspending a plurality of the quenching objects 100 on the quenching tool 1 by inserting the quenching tool 1 into the object through hole 100h, and a step S4 of immersing the quenching tool 1 and the quenching objects 100 suspended on the quenching tool 1 in a cooling oil 211. In the step S2 of suspending, each of the quenching objects 100 is disposed on the quenching tool 1 such that a contact state between the quenching tool 1 and the through hole inner circumferential surface 100s of the object through hole 100h is line contact.

In the quenching method, the quenching object 100 is suspended on the quenching tool 1 in a state of line contact. As a result, the quenching object 100 becomes unstable when immersed in the cooling oil 211. When the vapor film 6 generated on the surface of the quenching object 100 is separated, the quenching object 100 receives the reaction force F, which allows the quenching object 100 to move slightly. A slight movement of the quenching object 100 promotes the separation of a new vapor film 6. As a result, the separation of the first vapor film 6 triggers the successive separations of the vapor films 6 to occur, and thus the time from the timing at which the separation of the first vapor film 6 occurs to the timing at which the separation of the vapor film 6 is completed becomes shorter. Therefore, the influence of the difference in the timing at which the vapor film 6 is separated on the result of the quenching can be suppressed.

In the step S1 of preparing in the quenching method described above, a round rod having a constant outer diameter smaller than the inner diameter of the object through hole 100h and a length longer than that of the object through hole 100h is prepared as the quenching tool 1. The round rod allows the quenching object 100 to be suspended in an unstable state.

### Experimental Examples 1 and 2

It was confirmed by carrying out Experimental Examples 1 and 2 that the quenching method of the first disclosure has the effect of suppressing the influence of the vapor film 6 on the result of the quenching described above.

In Experimental Example 1, it was confirmed whether there was a difference in the quenching result between a case in which the movement of the quenching object 100 was not restricted (a first condition: an example) and a case in which the movement of the quenching object 100 was restricted (a second condition: a comparative example).

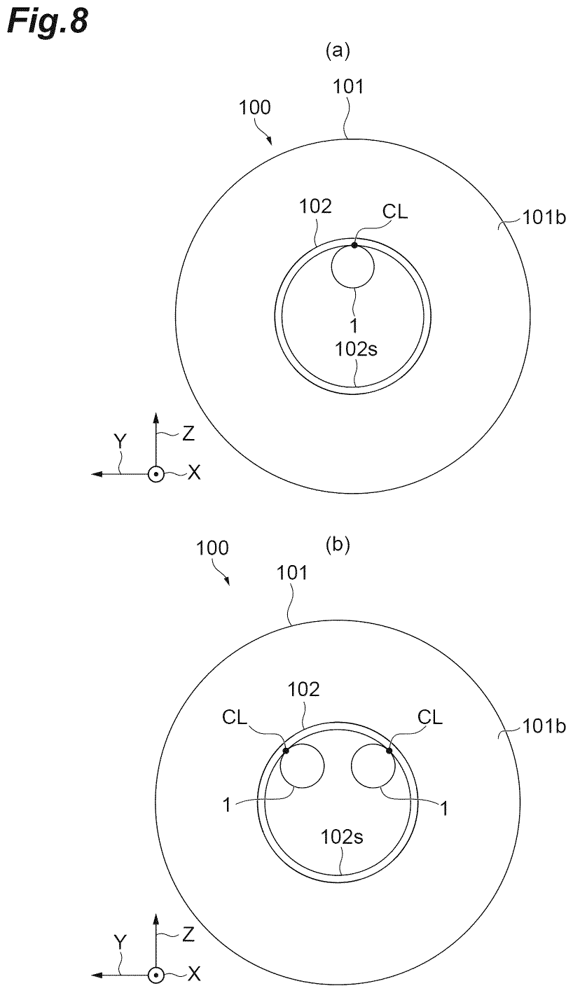

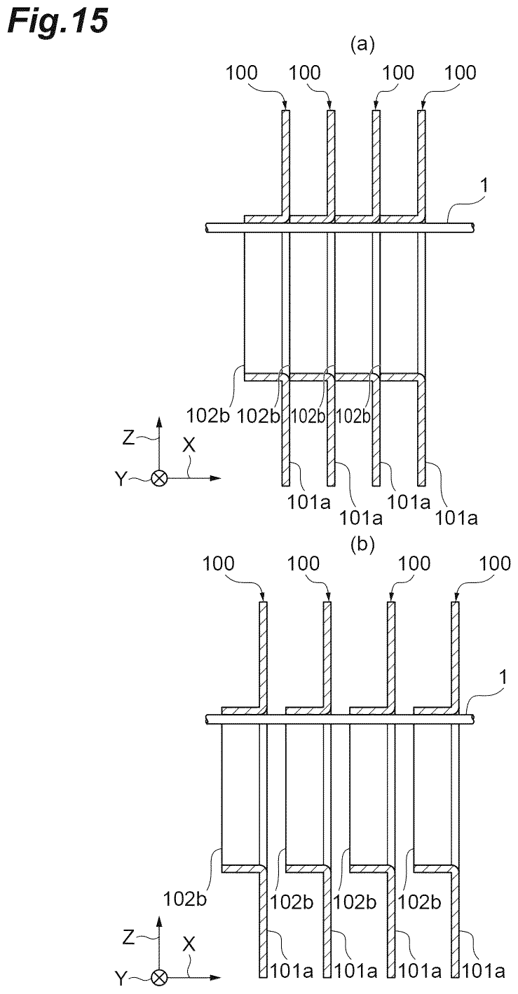

FIG. 8(a) shows a configuration for the first condition. The first condition is based on the quenching method of the first disclosure. The quenching object 100 was suspended by the quenching tool 1 that is a single round rod. FIG. 8(b) shows a configuration for the second condition. The second condition is based on the quenching method of the comparative example. In the comparative example, the quenching object 100 was suspended by the quenching tool 1A that is two round rods. According to this configuration, the swing described above (see FIG. 4(a)), which is a first movement mode, is restricted. A plurality of quenching objects 100 were prepared for each of the first condition and the second condition. For example, the plurality of quenching objects 100 suspended on the quenching tool 1 were immersed in the cooling oil 211. Several different types of quenching objects 100 in arrangement on the quenching tool 1, such as quenching objects 100 in contact with each other (see FIG. 15(a)) and quenching objects 100 separated from each other (see FIG. 15(b)), were prepared. The warpage of the race 101 and the roundness of the lip 102 were used as indexes for evaluating the quenching result. The average value of a plurality of measurement values obtained from the plurality of quenching object 100 was calculated.

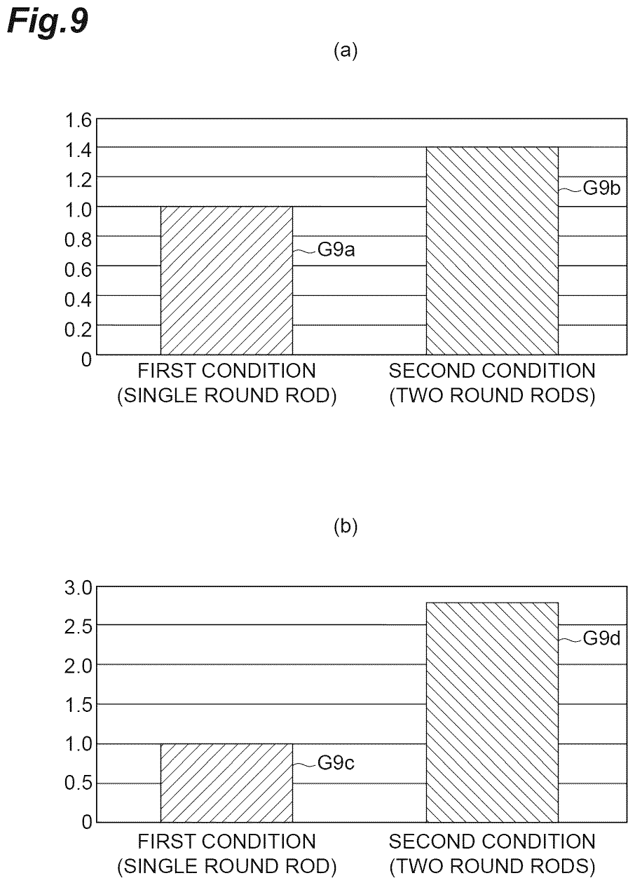

FIG. 9(a) shows the result of evaluation of the warpage of the race 101. In a case in which the warpage of the race 101 is small, it can be said that the quenching result is good. In the graph of FIG. 9(a), the result under the first condition and the result under the second condition are shown as relative values with the result under the first condition as the reference. In a case in which the result under the first condition (a graph G9a) was taken as 1, the result under the second condition (a graph G9b) was 1.4. It was found that better quenching result was obtained when the movement (the swing) of the quenching object 100 was not restricted.

FIG. 9(b) shows the result of evaluation of the roundness of the lip 102. Even in a case in which the roundness of the lip 102 is small, it can be said that the quenching result is good. In the graph of FIG. 9(b), the result under the first condition and the result under the second condition are shown as relative values with the result under the first condition as the reference. In a case in which the result under the first condition (a graph G9c) was taken as 1, the result under the second condition (a graph G9d) was 2.8. It was found that better quenching result was obtained when the movement (the swing) of the quenching object 100 was not restricted.

In Experimental Example 2, it was also confirmed whether there was a difference in the quenching result between a case in which the movement of the quenching object 100 was not restricted (a third condition: an example) and a case in which the movement of the quenching object 100 was restricted (a fourth condition: a comparative example). The movement restricted by the fourth condition is different from the movement restricted by the second condition.

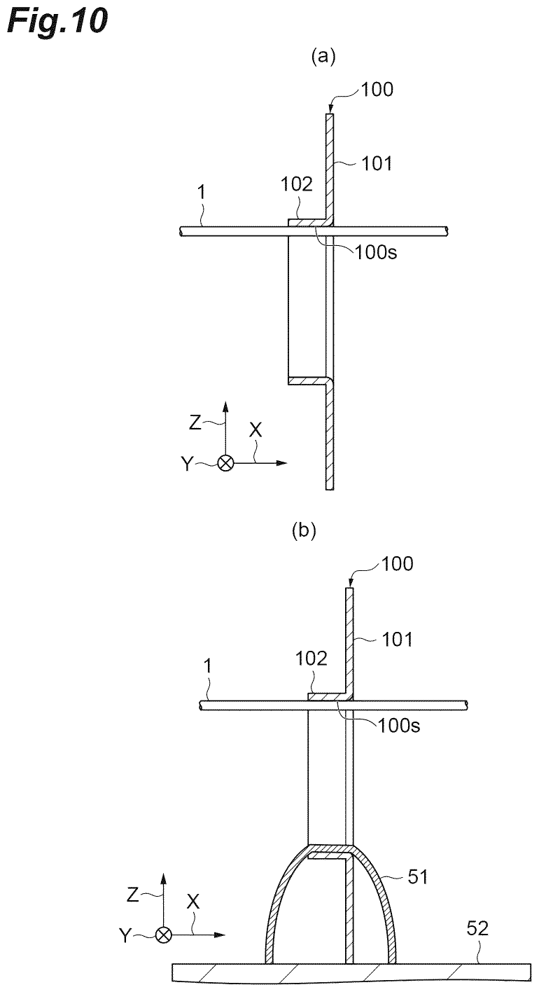

FIG. 10(a) shows a configuration for the third condition. The third condition is based on the quenching method of the first disclosure. The quenching object 100 was suspended by the quenching tool 1 that is a single round rod. FIG. 10(b) shows a configuration for the fourth condition. The fourth condition is based on the quenching method of the comparative example. In the comparative example, the quenching object 100 was also suspended by the quenching tool 1 that is a single round rod. In the comparative example, a wire 51 was passed through the object through hole 100h of the quenching object 100, and both ends of the wire 51 were fixed to a base 52.

According to this configuration, the movement in the direction of the object axis A described above (see FIG. 4(b)), which is a second movement mode, is restricted. The details of the experiment, such as the plurality of quenching objects 100 used in the experiment and the arrangement of the quenching objects 100 relative to the quenching tool 1, were the same as those of Experimental Example 1.

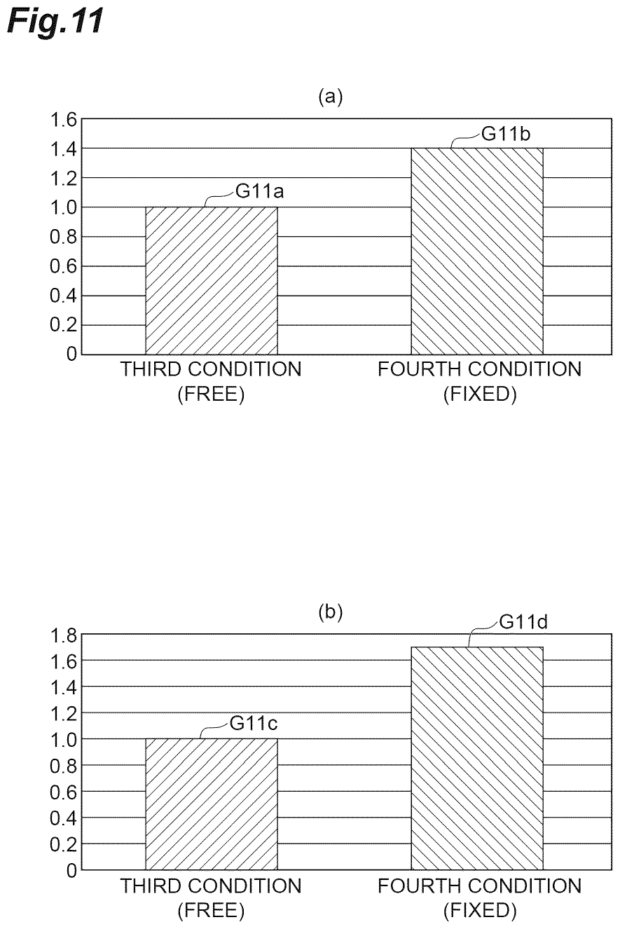

FIG. 11(a) shows the result of evaluation of the warpage of the race 101. In the graph of FIG. 11(a), the result under the third condition and the result under the fourth condition are shown as relative values with the result under the third condition as the reference. In a case in which the result under the third condition (a graph G11a) was taken as 1, the result under the fourth condition (a graph G11b) was 1.4. It was found that better quenching result was obtained when the movement (the movement in the direction of the object axis A) of the quenching object 100 was not restricted.

FIG. 11(b) shows the result of evaluation of the roundness of the lip 102. Even in a case in which the roundness of the lip 102 is small, it can be said that the quenching result is good. In the graph of FIG. 11(b), the result under the third condition and the result under the fourth condition are shown as relative values with the result under the third condition as the reference. In a case in which the result under the third condition (a graph G11c) was taken as 1, the result under the fourth condition (a graph G11d) was 1.7. It was found that better quenching result was obtained when the movement (the movement in the direction of the object axis A) of the quenching object 100 was not restricted.

In the above description, it has been suggested to move the quenching object 100 in order to promote the separation of the vapor film 6. The reaction force F generated when the vapor film 6 is separated was utilized as the driving force for moving the quenching object 100. The movement of the quenching object 100 for promoting the separation of the vapor film 6 may result from other driving forces. In a second disclosure and a third disclosure, a configuration for actively moving the quenching object 100 in order to promote the separation of the vapor film 6 is exemplified.

The devices of the second disclosure and the third disclosure, which will be described below, employ a force other than the reaction force F as the main driving force for moving the quenching object 100. However, the devices of the second disclosure and the third disclosure do not prevent the reaction force F from being used as a driving force. In a case in which the devices of the second disclosure and the third disclosure are used, the quenching tool 1 illustrated in the first disclosure may be employed. In a case in which the devices of the second disclosure and the third disclosure are used, the devices in which the quenching object 100 is fixed such that it does not move due to the reaction force caused by the vapor film 6 may be employed. Therefore, in the devices of the second disclosure and the third disclosure, the quenching tool 1 shown in the first disclosure is not an essential component.

### Second Disclosure

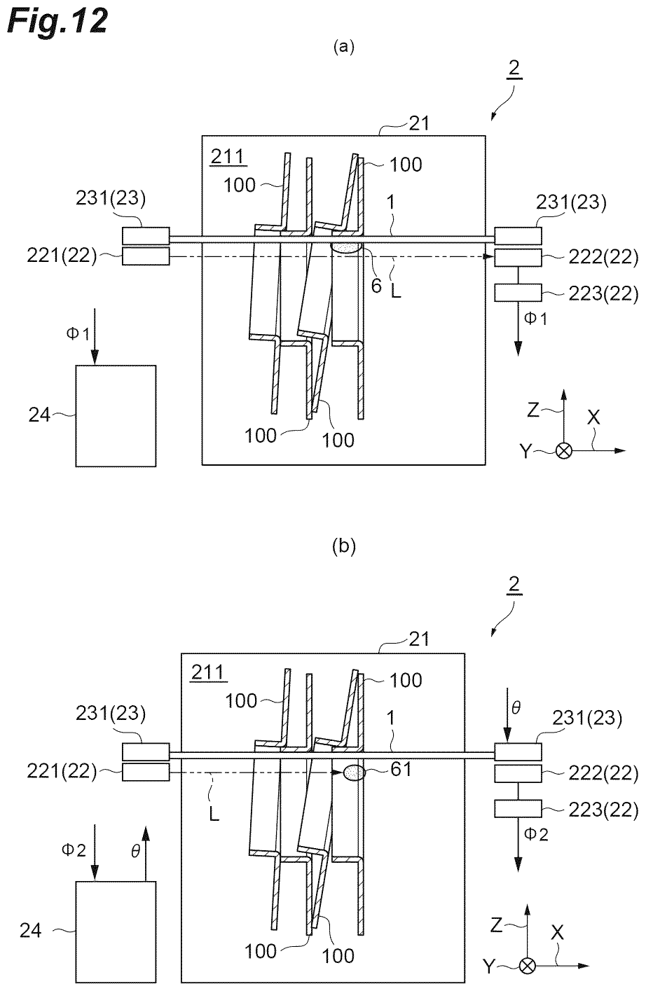

As the second disclosure, a device for moving the quenching object 100 by vibrating the quenching tool I will be described. As shown in FIG. 12(a), a quenching device 2 includes a cooling tank 21, a detection unit 22, a promotion unit 23, and a controller 24.

The cooling tank 21 is filled with a cooling oil 211. The detection unit 22 is disposed outside the cooling tank 21. The detection unit 22 detects that the separation of the vapor film 6 from the quenching object 100 has started. The detection unit 22 includes, for example, a laser generating portion 221, a laser receiving portion 222, and a signal output portion 223.

A laser L emitted from the laser generating portion 221 passes through, for example, the inside of the object through hole 100h. When the vapor film 6 is not present on an optical path of the laser L, the laser L reaches the laser receiving portion 222. When the vapor film 6 is not present on the optical path of the laser L, there may be several states. For example, there may be a state in which the vapor film 6 is present on the surface of the object through hole 100h, but the vapor film 6 does not reach the optical path of the laser L. Therefore, when the laser receiving portion 222 is receiving the laser L, it may be determined that the separation of the vapor film 6 has not started.

The detection unit 22 may be constituted by a component that generates an ultrasonic wave instead of a laser and a component that receives the ultrasonic wave.

When the vapor film 6 is separated from the surface of the object through hole 100h and is positioned as a bubble 61 on the optical path of the laser L, the progression of the laser L is hindered. As a result, a change in the intensity of the laser L incident on the laser receiving portion 222 occurs. In a case in which a change in the intensity of the laser L occurs, it may be determined that the separation of the vapor film 6 has started.

The detection unit 22 may detect the start of the separation of the vapor film 6 itself. The detection unit 22 may detect the movement of the quenching object 100 caused by the separation of the vapor film 6, instead of detecting the start of the separation of the vapor film 6 itself. For example, in a case in which the quenching device 2 employs the quenching tool 1 of the first disclosure, the movement of the quenching object 100 is caused by the separation of the vapor film 6. Therefore, the detection unit 22 is able to detect the movement of the quenching object 100.

In a case in which it is determined that the separation of the vapor film 6 has not started, the detection unit 22 may output a detection signal φ1 indicating a state in which the separation of the vapor film 6 has not started. In a case in which it is determined that the separation of the vapor film 6 has started, the detection unit 22 may output a detection signal φ2 indicating a state in which the separation of the vapor film 6 has started. The detection unit 22 may omit the output of the detection signal φ1. Only in a case in which it is determined that the separation of the vapor film 6 has started, the detection unit 22 may output the detection signal φ2.

The controller 24 receives the detection signals φ1 and φ2 and performs operations according to the respective signals. When the controller 24 receives the detection signal φ1 or when there is no input of the detection signal φ2, the controller 24 does not output a drive signal θ (see FIG. 12(a)). When the controller 24 receives the detection signal φ2, the controller 24 outputs the drive signal θ (see FIG. 12(b)).

The promotion unit 23 promotes the separation of the vapor film 6. The promotion unit 23 is a vibrator 231 (a vibration portion) provided at at least one end portion of the quenching tool 1. There is no particular limitation on the vibration generated by the vibrator 231. The vibrator 231 may vibrate in a direction orthogonal to the object axis A (the Z direction). The vibrator 231 may vibrate in a direction along the object axis A (the X direction). The vibrator 231 may generate a sinusoidal vibration. The vibrator 231 may generate a random vibration. The amplitude of the vibration may be, for example, about 1 to 30 times the outer diameter of the quenching object 100. The frequency of the vibration may be about 0.01 Hz to 1 Hz.

When the vibrator 231 generates the vibration, the quenching tool 1 also vibrates. Due to the vibration of the quenching tool 1, the quenching object 100 also vibrates. Therefore, the separation of the vapor film 6 from the quenching object 100 is promoted.

According to the quenching device 2 of the second disclosure, by detecting the separation of the vapor film 6, it is possible to perform an operation for promoting the separation of the vapor film 6. As a result, it is possible to shorten the period from the timing at which the separation of the first vapor film 6 occurs to the timing at which the separation of the last vapor film 6 occurs. Therefore, the influence of the vapor film on the result of the quenching can be suppressed.

In short, the quenching device 2 of the second disclosure performs quenching processing on the quenching object 100 including the race 101 provided with the object through hole 100h. The quenching device 2 includes a cooling tank 21 filled with a cooling oil 211 for cooling the quenching object 100, a detection unit 22 configured to detect that separation of a vapor film 6 from the quenching object 100 has started after the vapor film 6 is generated on a surface of the quenching object 100 by the quenching object 100 being immersed in the cooling oil 211, a promotion unit 23 configured to promote the separation of the vapor film 6 from the quenching object 100, and a controller 24 configured to receive a detection signal φ2 from the detection unit 22 indicating that the separation of the vapor film 6 has started and to output a drive signal θ for causing the promotion unit 23 to perform an operation for promoting the separation of the vapor film 6 using the detection signal φ2.

The quenching device 2 detects the start of the separation of the vapor film 6 by the detection unit 22. In the quenching device 2, when the separation of the vapor film 6 is detected, this detection triggers the separation of the vapor film 6 to be promoted by the promotion unit 23. According to this configuration, it is possible to reliably promote the separation of the vapor film 6 regardless of whether the quenching object 100 is unstable or not. Therefore, the influence of the difference in the timing at which the vapor film 6 is separated on the result of the quenching can be suppressed.

The detection unit 22 of the quenching device 2 described above has the laser generating portion 221 that outputs the laser L, the laser receiving portion 222 that receives the laser, and the signal output portion 223 that outputs the detection signal φ2 when the laser receiving portion 222 does not receive the laser L. According to this configuration, the start of the separation of the vapor film 6 can be detected by a simple mechanism.

The promotion unit 23 of the quenching device 2 described above has the quenching tool 1 that is a rod body which is inserted into the object through hole 100h and on which the quenching object 100 is suspended, and the vibrator 231 which vibrates the quenching tool 1 in response to the input of the drive signal θ. According to this configuration, it is possible to favorably promote the separation of the vapor film 6.

### Third Disclosure

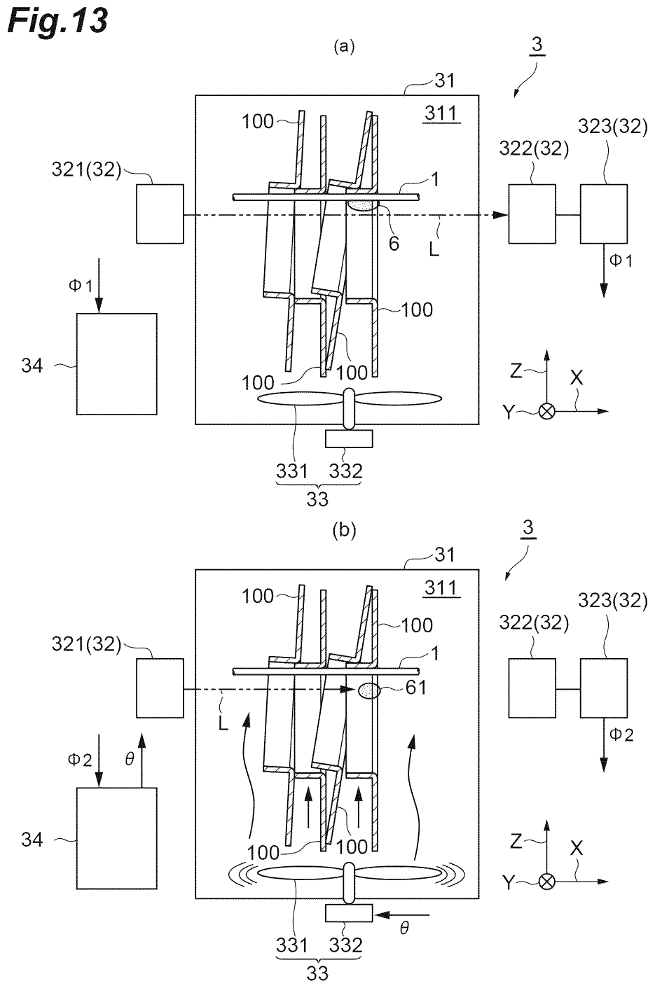

As a third disclosure, a device for moving the quenching object 100 by a flow of a cooling oil 311 will be illustrated. As shown in FIG. 13(a), a quenching device 3 includes a cooling tank 31, a detection unit 32, a promotion unit 33, and a controller 34. The quenching device 3 of the third disclosure differs from the quenching device 3 of the second disclosure only in that the promotion unit 33 generates the flow of the cooling oil 311. Therefore, the cooling tank 31, the detection unit 32, and the controller 34 are the same as the cooling tank 21, the detection unit 22, and the controller 34, respectively, and therefore detailed description thereof will be omitted.

The promotion unit 33 of the third disclosure is a fan 331. The fan 331 (a flow generating portion) is disposed inside the cooling tank 31 and is driven by a motor 332 disposed outside the cooling tank 31. In FIG. 13(a), the fan 331 is disposed at the bottom of the cooling tank 31, but the present disclosure is not limited to this arrangement. The fan 331 may be disposed near a side wall of the cooling tank 31.

When the promotion unit 33 receives the drive signal θ from the controller 34, the promotion unit 33 starts rotating the fan 331 (see FIG. 13(b)). The fan 331 included in the quenching device 3 of the third disclosure starts operating when the separation of the vapor film 6 starts. As an example, the frequency of the fan 331 may be about 10 Hz to 100 Hz.

The promotion unit 33 may rotate the fan at a predetermined speed even when the separation of the vapor film 6 has not started. In this case, when the separation of the vapor film 6 starts, the promotion unit 33 may rapidly increase the rotation speed of the fan 331.

According to the quenching device 3 of the third disclosure, by detecting the separation of the vapor film 6, it is also possible to perform an operation for promoting the separation of the vapor film 6. As a result, it is possible to shorten the period from the timing at which the separation of the first vapor film 6 occurs to the timing at which the separation of the last vapor film 6 occurs. Therefore, the influence of the vapor film 6 on the result of the quenching can be suppressed.

The promotion unit 33 of the quenching device 3 described above has the fan 331 that is installed in the cooling tank 31 and generates the flow of the cooling oil 211 inside the cooling tank 31 due to the input of the drive signal θ. According to this configuration, it is also possible to favorably promote the separation of the vapor film 6.

### Fourth Disclosure

In the first to third disclosures, it has been suggested to move the quenching object 100 in order to promote the separation of the vapor film 6. The promotion of the separation of the vapor film 6 is not limited to moving the quenching object 100. For example, it is also possible to promote the separation of the vapor film 6 by reducing a pressure.

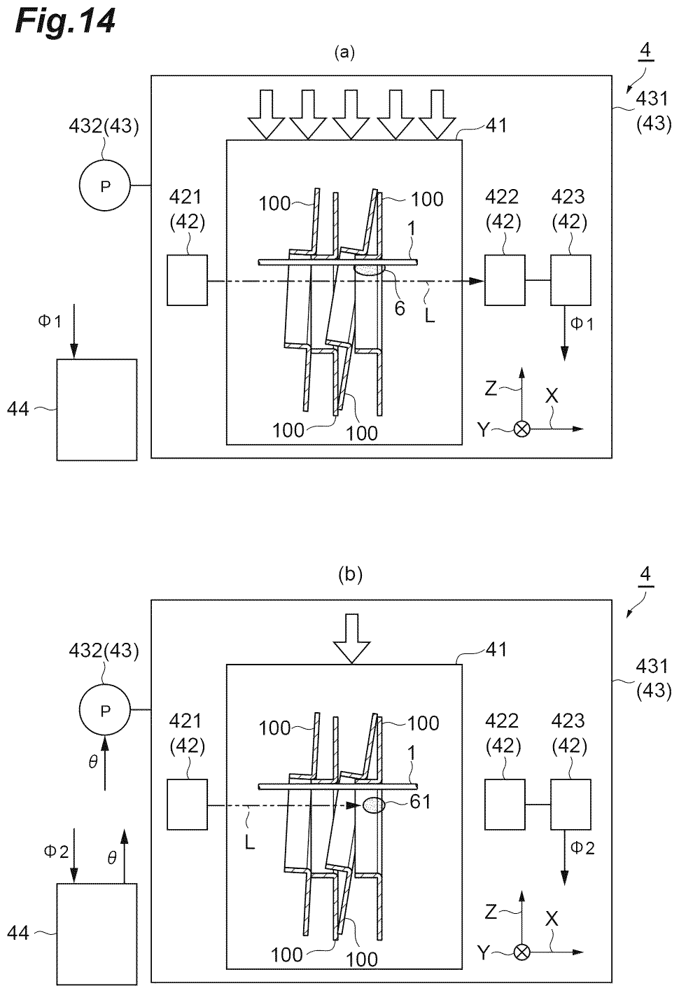

As shown in FIG. 14(a), a quenching device 4 includes a cooling tank 41, a detection unit 42, a promotion unit 43, and a controller 44. The quenching device 4 of the fourth disclosure differs from the quenching device 4 of the second disclosure only in that the promotion unit 43 is configured for reducing a pressure. Therefore, the cooling tank 41, the detection unit 42, and the controller 44 are the same as the cooling tank 21, the detection unit 22, and the controller 34, respectively, and therefore detailed description thereof will be omitted.

The promotion unit 43 has a pressure reduction housing 431 and a pump 432 (a pressure reduction portion). The pressure reduction housing 431 accommodates the cooling tank 41. The inside of the pressure reduction housing 431 can be kept airtight. The pump 432 is connected to the pressure reduction housing 431. The pressure inside the pressure reduction housing 431 can be reduced by the pump 432. For example, the internal pressure of the pressure reduction housing 431 before the pressure reduction may be 1014 hPa (1 atmosphere). The internal pressure of the pressure reduction housing 431 may be 200 kPa after the pressure reduction. It is sufficient that the internal pressure of the pressure reduction housing 431 after the pressure reduction is lower than that before the pressure reduction. For example, the internal pressure after the pressure reduction may be half of the internal pressure before the pressure reduction.

When the promotion unit 43 receives the drive signal θ from the controller 44, the promotion unit 43 starts driving the pump 432 (see FIG. 14(b)). The pump included in the quenching device 4 of the fourth disclosure starts operating when the separation of the vapor film 6 starts.

The promotion unit 43 of the quenching device 4 described above includes the pressure reduction housing 431 that accommodates the cooling tank 41, and the pump 432 that reduces the pressure inside the pressure reduction housing 431 below atmospheric pressure due to the input of a drive signal θ4. According to this configuration, it is also possible to favorably promote the separation of the vapor film 6.

The quenching method and the quenching device of the present disclosure are not limited to the contents of the first disclosure described above.

### Modification Example 1

As shown in FIG. 15(a), a plurality of quenching objects 100 may be suspended on the quenching tool 1. The quenching objects 100 may be in contact with each other. The lip tip end 102b of the quenching object 100 may be in contact with the race main surface 101a of another quenching object 100 adjacent thereto. With such an arrangement, the plurality of quenching objects 100 can be processed while suppressing the influence of the vapor film 6 on the result of the quenching.

In a quenching method of Modification Example 1, in the step S2 of suspending, the plurality of quenching objects 100 disposed on the quenching tool 1 are brought into contact with each other. The number of quenching objects 100 that can be disposed on the quenching tool 1 can be increased.

### Modification Example 2

As shown in FIG. 15(b), in a case in which a plurality of quenching objects 100 are suspended, the quenching objects 100 may be spaced apart from each other. The lip tip end 102b of the quenching object 100 is spaced apart from the race main surface 101a of another quenching object 100 adjacent thereto by a predetermined distance. The predetermined distance may be any value greater than zero. Even with such an arrangement, the plurality of quenching objects 100 can be processed while suppressing the influence of the vapor film 6 on the result of the quenching.

In a quenching method of Modification Example 2, in the step S2 of suspending, the plurality of quenching objects 100 disposed on the quenching tool 1 are spaced apart from each other. The influence of the difference in the timing at which the vapor film 6 is separated on the result of the quenching can be suppressed.

### Modification Example 3

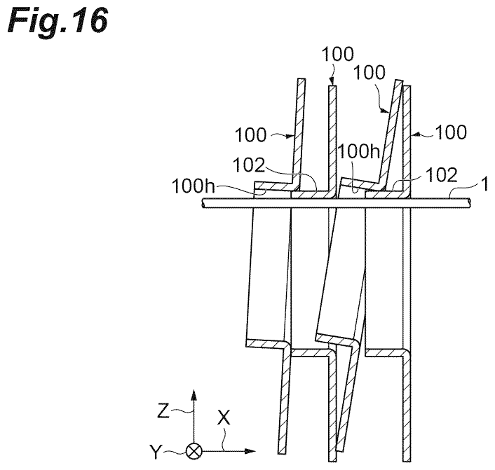

As shown in FIG. 16, in a case in which a plurality of quenching objects 100 are suspended, the quenching objects 100 may be overlapped with each other. For example, a state in which a part of the lip 102 of one quenching object 100 is fitted into the object through hole 100h of the other quenching object 100 may occur. Even with such an arrangement, the plurality of quenching objects 100 can be processed while suppressing the influence of the vapor film 6 on the result of the quenching. The number of quenching objects 100 that is suspended on the quenching tool 1 can also be increased. In the arrangement of Modification Example 3, the plurality of quenching objects 100 are randomly disposed on the quenching tool 1. As a result, there is no need to align the plurality of quenching objects 100. Therefore, the management costs for quenching can be reduced.

In a quenching method of Modification Example 3, in the step S2 of suspending, a part of the quenching object 100 is overlapped with another quenching object 100 adjacent thereto. Even with such an arrangement, the number of quenching objects 100 that can be disposed on the quenching tool 1 can be increased.

### Modification Example 4

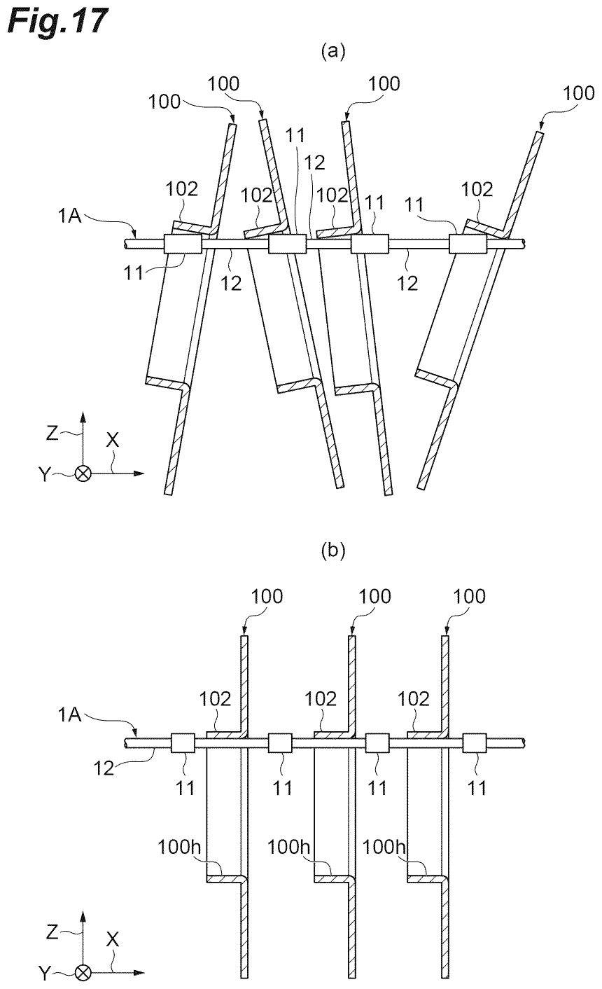

The quenching tool 1 is not limited to a round rod having a certain diameter. As shown in FIG. 17(a), a quenching tool 1A may have large diameter portions 11 and small diameter portions 12. The large diameter portions 11 and the small diameter portions 12 are alternately disposed. The intervals between the large diameter portions 11 and the large diameter portions 11 (the lengths of the small diameter portions 12) may be regular or irregular.

In this configuration, the quenching object 100 is disposed to straddle the large diameter portion 11 and the small diameter portion 12. In this case, the quenching object 100 is suspended at an angle, and thus the quenching object 100 can be supported in a more unstable state. Therefore, similarly to the first disclosure, the plurality of quenching objects 100 can be processed while suppressing the influence of the vapor film 6 on the result of the quenching.

In a quenching method of Modification Example 4, in the step S1 of preparing, a rod body having an outer diameter smaller than the inner diameter of the object through hole 100h and a length longer than that of the object through hole 100h is prepared as the rod body. The rod body includes the large diameter portions 11 each having a first outer diameter and the small diameter portions 12 each having a second outer diameter smaller than the first outer diameter. The large diameter portions 11 and the small diameter portions 12 are alternately disposed along the object axis A of the rod body. Therefore, the influence of the difference in the timing at which the vapor film 6 is separated on the result of the quenching can also be suppressed.

### Modification Example 5

In the quenching tool 1A, for example, the length of the small diameter portion 12 may be greater than the width of the lip 102. The width of the lip 102 may be defined as the length from the race main surface 101a to the lip tip end 102b. In a case in which the entire quenching object 100 is located on the small diameter portion 12, it is sufficient that a gap is present between the quenching object 100 and the large diameter portion 11. This gap allows the quenching object 100 to move in an axial direction. As an example, the length of the small diameter portion 12 may be 1.5 times or more the width of the lip 102.

In this configuration, the quenching object 100 is disposed on the small diameter portion 12. The small diameter portion 12 is in contact with the inner circumferential surface of the object through hole 100h.

In Modification Example 5, the movement of the quenching object 100 in the direction of the object axis A is not restricted. Therefore, similarly to the first disclosure, the plurality of quenching objects 100 can be processed while suppressing the influence of the vapor film 6 on the result of the quenching.

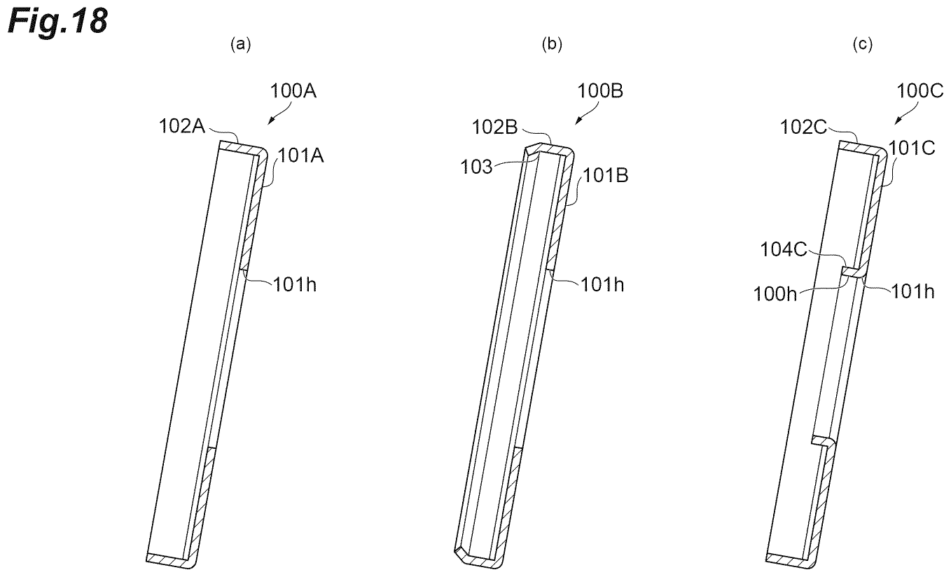

For example, the quenching method and the quenching device may be applied to the quenching objects 100A, 100B, and 100C shown in FIGS. 18(a), 18(b), and 18(c).

### Examples of Quenching Object

The quenching object 100A shown in FIG. 18(a) includes a race 101A and a lip 102A. The race 101A has a race through hole 101h formed therein. The lip 102A is erected from the outer circumferential edge of the race 101A. The lip 102A extends in a straight line from the race 101A. The lip 102A does not include a bent portion between a portion connected to the race 101A and the tip end thereof.

The quenching object 100B shown in FIG. 18(b) includes a race 101B and a lip 102B. The race 101B has a race through hole 101h formed therein. The lip 102B is erected from the outer circumferential edge of the race 101B. The lip 102B includes a curled portion 103 between a portion connected to the race 101B and the tip end thereof. The lip 102B is curved inward starting from the curled portion 103. The inner diameter of the tip end portion of the lip 102B is smaller than the outer diameter of the race 101B.

The quenching object 100C shown in FIG. 18(c) has a race 101C, an inner lip 104C, and an outer lip 102C. The inner lip 104C forms an object through hole 100h together with a race through hole 101h provided in the race 101C. The outer lip 102C is erected from the outer circumferential edge of the race 101C. The direction in which the outer lip 102C is erected is the same as the direction in which the inner lip 104C is erected. The height of the outer lip 102C may be greater than the height of the inner lip 104.

### Reference Signs List

1 Quenching tool, 2, 3, 4 Quenching device, 6 Vapor film, 11 Large diameter portion, 12 Small diameter portion, 21, 31, 41 Cooling tank, 22, 32, 42 Detection unit, 23, 33, 43 Promotion unit, 24, 34, 44 Controller, 100, 100A, 100B, 100C Quenching object, 211 Cooling oil (cooling liquid), 221 Laser generating portion, 222 Laser receiving portion, 223 Signal output portion, 231 Vibrator (vibration portion), 331 10 Fan (flow generating portion), 432 Pump (pressure reduction portion), L Laser, θ Drive signal, φ1, φ2 Detection signal

1. A quenching method for a quenching object including a disk-shaped portion provided with a through hole, comprising:
a step of preparing a rod body;
a step of suspending a plurality of the quenching objects on the rod body by inserting the rod body into the through hole; and
a step of immersing the rod body and the quenching objects suspended on the rod body in a cooling liquid,
wherein, in the step of suspending, each of the quenching objects is disposed on the rod body such that a contact state between the rod body and an inner circumferential surface of the through hole is point contact or line contact.

2. The quenching method according to claim 1, wherein, in the step of preparing, a round rod having a constant outer diameter smaller than an inner diameter of the through hole and a length longer than that of the through hole is prepared as the rod body.

3. The quenching method according to claim 2, wherein, in the step of suspending, the plurality of quenching objects disposed on the rod body are brought into contact with each other.

4. The quenching method according to claim 2, wherein, in the step of suspending, the plurality of quenching objects disposed on the rod body are separated from each other.

5. The quenching method according to claim 2, wherein, in the step of suspending, a part of the quenching object is overlapped with another quenching object adjacent thereto.

6. The quenching method according to claim 1,
wherein, in the step of preparing, a rod body having an outer diameter smaller than an inner diameter of the through hole and a length longer than that of the through hole is prepared as the rod body,
wherein the rod body includes large diameter portions each having a first outer diameter and small diameter portions each having a second outer diameter smaller than the first outer diameter, and
wherein the large diameter portions and the small diameter portions are alternately disposed along an axis of the rod body.

7. A quenching device for a quenching object including a disk- shaped portion provided with a through hole, comprising:
a cooling tank filled with a cooling liquid for cooling the quenching object;
a detection unit configured to detect that separation of a vapor film from the quenching object has started after the vapor film is generated on a surface of the quenching object by the quenching object being immersed in the cooling liquid;
a promotion unit configured to promote the separation of the vapor film from the quenching object; and
a controller configured to receive a detection signal from the detection unit indicating that the separation of the vapor film has started and to output a drive signal for causing the promotion unit to perform an operation for promoting the separation of the vapor film using the detection signal.

8. The quenching device according to claim 7, wherein the detection unit has
a laser generating portion configured to output a laser,
a laser receiving portion configured to receive the laser, and
a signal output portion configured to output the detection signal when the laser receiving portion does not receive the laser light.

9. The quenching device according to claim 8, wherein the promotion unit has
a rod body which is inserted into the through hole and on which the quenching object is suspended, and
a vibration portion configured to vibrate the rod body due to an input of the drive signal.

10. The quenching device according to claim 8, wherein the promotion unit has a flow generating portion installed in the cooling tank and configured to generate a flow of the cooling liquid inside the cooling tank due to an input of the drive signal.

11. The quenching device according to claim 8, wherein the promotion unit bas
a housing configured to accommodate the cooling tank, and
a pressure reduction portion configured to reduce a pressure inside the housing below atmospheric pressure due to an input of the drive signal.
